(19) United States
(12) Patent Application Publication
(10) Pub. No.: US 2010/0090645 A1
(43) Pub. Date: Apr. 15, 2010

(54) Composite charging cradle for rechargeable battery

(76) Inventor: Po-chin Huang, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/285,638

(22) Filed: Oct. 10, 2008

(51) Int. Cl. H02J 7/00

(52) U.S. Cl. 320/110

(57) ABSTRACT

The present invention provides a composite charging cradle for charging rechargeable batteries of several different specifications to solve the problem of confusion between the specifications of rechargeable batteries. The charging cradle includes a cradle body and a circuit board disposed in the cradle body. The cradle body has a plurality of insertion slots for inserting rechargeable batteries of different specifications therein, and each of the insertion slots is provided therein with at least one set of terminals for outputting power; the circuit board is disposed in the foregoing cradle body, including a plurality of power input ports of different specifications exposed out of the cradle body, and an integrated unit for integrating all the foregoing power input ports; the integrated unit is electrically connected with each set of terminals such that rechargeable batteries and plug adapters of several different specifications can be charged according to the present invention.

### BACKGROUND OF THE INVENTION

(a) Field of the Invention

The present invention relates to the technical field of rechargeable batteries, and more particularly to a charging cradle preset with several power input and output specifications for charging rechargeable batteries of several different specifications.

(b) Description of the Prior Art

In recent years, mobile phones have gradually become necessities for life as everyone has a mobile phone, and even someone owns more than two mobile phones at the same time, from rare luxury goods in early days. Mobile phones also belong to a portable electronic device with a short product life, many variations in the style and a lasting increase in the functions, so their replacement rate is relatively high.

However, the rechargeable battery and the charger must be additionally purchased or replaced whenever a mobile phone is purchased or replaced. Even though the mobile phones are of the same brand but of different models, there is still a problem of differences between their specifications, such as the thickness of rechargeable batteries, the types of plug adapters on mobile phone bodies, the positions of conductive terminals for electrically connecting the rechargeable battery and the mobile phone, even slight differences between the output voltages, etc., thereby resulting in confusion on the market.

With the problem of confusion between the specifications of the above rechargeable batteries and chargers becoming increasingly severe, a user needs to repurchase a new rechargeable battery and a new charger (generally also referred to as a seat charger) whenever he/she replaces a mobile phone. The used chargers are hard to accommodate and occupy space, and further cause an environmental protection problem. In view of the above-mentioned circumstances, the inventors researched and improved a charging cradle for a rechargeable battery to solve the problem of confusion between the specifications of the foregoing chargers and rechargeable batteries.

### SUMMARY OF THE INVENTION

The primary objective of the present invention is to enable a charging cradle to provide for the insertion of charging adapters of different specifications to obtain power therefrom as well as to enable rechargeable batteries of different specifications to be charged, thus capable of solving the problem of incompatibility between rechargeable batteries and charging cradles of different specifications as described above.

To achieve the above objective, the present invention provides a composite charging cradle for a rechargeable battery, which includes a cradle body and a circuit board disposed in the cradle body. The cradle body has a plurality of insertion slots for inserting the rechargeable battery of different specifications therein, and each of the insertion slots is provided therein with at least one set of terminals for outputting power; the circuit board is disposed in the foregoing cradle body and includes a plurality of power input ports of different specifications which are exposed out of the cradle body, and an integrated unit for integrating all the foregoing power input ports; the integrated unit is electrically connected with each of the sets of terminals such that rechargeable batteries of several different specifications can be charged according to the present invention.

In the implementation of the present invention, said integrated unit further includes a charging control unit, a voltage-stabilizing control unit, a constant current control unit, and a charging indication lamp which is exposed out of the cradle body.

Moreover, when there are two insertion slots, the two insertion slots are mutually spaced and arranged side by side, and a foolproof swing plate is disposed in the interval between the two insertion slots. Thus, when a rechargeable battery is inserted into one insertion slot, the foolproof swing plate is pushed toward the other insertion slot such that no rechargeable battery can be put into the other insertion slot, thereby preventing misoperation.

In the implementation of the present invention, said cradle body further includes a top cover and a bottom cover. The top cover is provided for the arrangement of the insertion slots, and the bottom cover opposingly matches and is located below the top cover in order to cover the circuit board. Said insertion slot can be provided on the wall thereof with a holding spring plate to elastically hold the rechargeable battery placed thereinto such that rechargeable batteries of different thickness can be securely placed into the insertion slots without wobble. The insertion slot is provided at one end thereof with a reset push rod to allow rechargeable batteries of different thickness to be held and positioned.

Compared with the prior art, the present invention provides a charger capable of charging rechargeable batteries and plug adapters of several different specifications, not only having the advantages of convenience in use and environmental protection, but also solving the problem of confusion between the specifications of rechargeable batteries. Particularly, it is suitable for use in the charging modules on the basis of the same brand, and hence has a very high industrial utilization value.

### BRIEF DESCRIPTION OF THE DRAWINGS

The implementation schemes suitable for the present invention will be hereinafter described with reference to the related drawings according to the technical means of the present invention.

FIG. 1 is a three-dimensional assembly drawing of the best embodiment according to the present invention.

FIG. 2 is a three-dimensional exploded view of the best embodiment according to the present invention.

FIG. 3 is a front sectional view of the best embodiment according to the present invention.

FIG. 4 is a schematic view showing a foolproof action during inserting a rechargeable battery according to the present invention.

FIG. 5 is a side sectional view of the best embodiment according to the present invention.

FIG. 6 is a schematic view showing the action of the reset push rod during inserting a rechargeable battery according to the present invention.

FIG. 7 is a schematic view showing the integrated unit of the best embodiment according to the present invention.

### DETAILED DESCRIPTION OF THE PREFERRED EMBODIMENTS

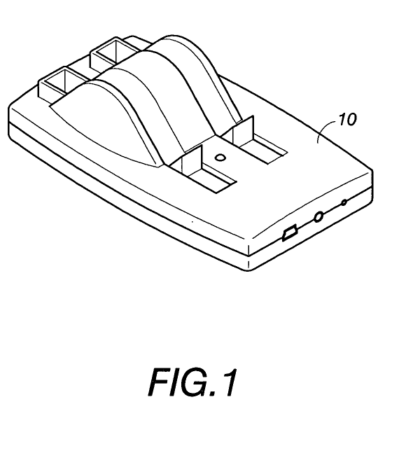

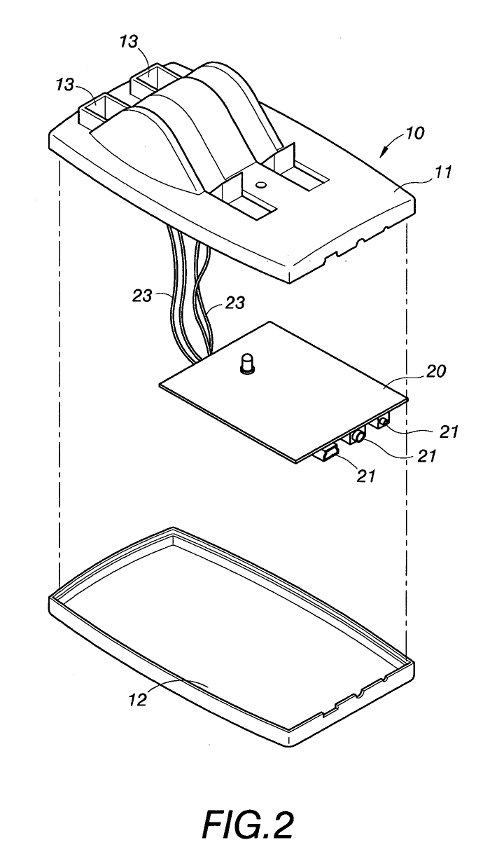

As illustrated in FIGS. 1 and 2, there are a three-dimensional assembly drawing and a three-dimensional exploded view of the best embodiment according to the present invention. The composite charging cradle for a rechargeable battery disclosed in this embodiment includes a cradle body 10 and a circuit board 20.

Wherein the cradle body 10 is formed by opposingly matching a top cover 11 and a bottom cover 12. The top cover 11 is provided with two insertion slots 13 for inserting rechargeable batteries of different specifications thereinto. The bottom cover 12 opposingly matches and is located below the top cover 11 to form a receiving space for the installation of the circuit board 20, and to cover and hide the circuit board 20 in the cradle body 10.

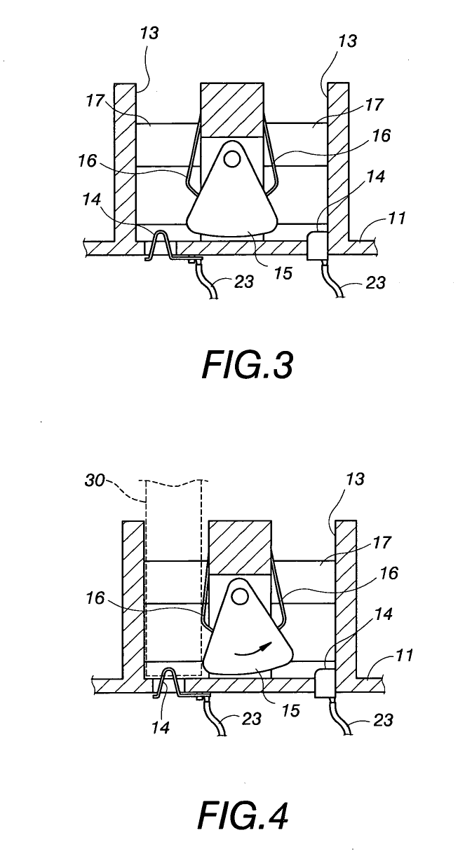

Referring to FIGS. 2 and 3, the foregoing two insertion slots 13 are mutually spaced and arranged side by side, and are provided at the bottoms thereof with one set of terminals 14 of different specifications for outputting power. A foolproof swing plate 15 is disposed in the interval between the two insertion slots 13. As illustrated in FIG. 4, when a rechargeable battery 30 is inserted into one insertion slot 13, the foolproof swing plate 15 is pushed toward the other insertion slot 13 such that no rechargeable battery 30 can be put into the other insertion slot 13, thereby achieving the foolproof effect that only one of the two insertion slots 13 can permit the insertion of the rechargeable battery 30.

Furthermore, to obtain a good positioning and inserting effect of the rechargeable battery 30 which is inserted, the insertion slot 13 is provided on the wall thereof with a holding spring plate 16 to hold the rechargeable battery 30 placed thereinto such that rechargeable batteries 30 of different thickness can be securely placed into the insertion slots 13 without wobble.

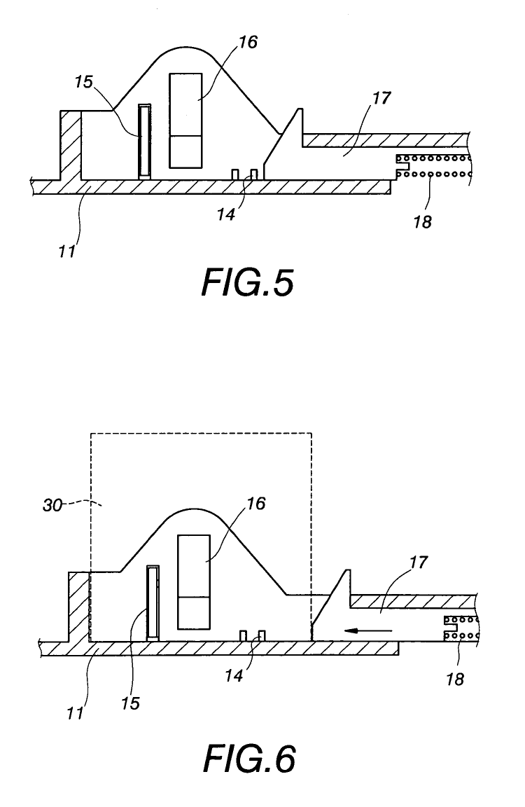

As illustrated in FIGS. 5 and 6, in the implementation of the present invention, the foregoing insertion slot 13 can be provided at the side end thereof with a reset push rod 17, and the reset push rod 17 is pushed by a spring 18 to cause a spring thrust. When the rechargeable battery 30 is placed into the insertion slot 13, the reset push rod 17 can be pushed back to compress the spring 18. The spring 18 pushes against the reset push rod 17 to hold the rechargeable battery 30 such that rechargeable batteries 30 of different thickness can be securely placed into the insertion slots 13. Moreover, there is an inclined plane on the front end of said reset push rod 17 to make the rechargeable battery smoother during the insertion and extraction motion thereof.

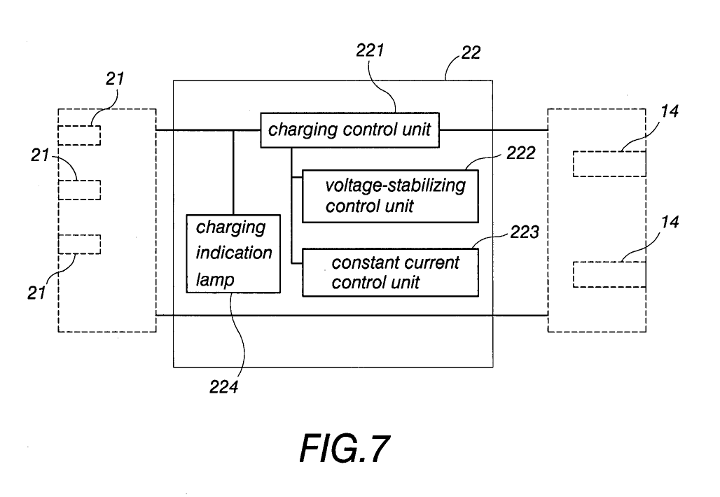

Referring to FIGS. 2, 3 and 7, FIG. 7 is a schematic view showing the integrated unit of the best embodiment according to the present invention. As disclosed in the drawing, the circuit board 20 is provided with a plurality of power input ports 21 of different specifications which are exposed out of the cradle body 10 for inputting power, such as conventional small circular connectors, conventional large circular connectors and Mini USB connectors, an integrated unit 22 for integrating all the foregoing power input ports, and a plurality of power output lines 23 for electrically connecting the integrated unit 22 and each set of terminals 14.

Said integrated unit 22 further includes a charging control unit 221, a voltage-stabilizing control unit 222, a constant current control unit 223, and a charging indication lamp 224 which is exposed out of the cradle body 10.

When in use, the user only needs to insert a power input plug of a charger (transformer) attached to the purchased mobile phone into the corresponding power input port 21, and then inserts the rechargeable battery into the insertion slot 13 whose specification of the set of terminals 14 meets that of the rechargeable battery to position it, thereby completing the preparation for charging. After the charger (transformer) is connected to a mains supply, the rechargeable battery can be charged through the charging cradle.

The arrangement of the charging indication lamp 224 enables the user to clearly discriminate whether the charging cradle is energized or not. Besides, the charging state of the rechargeable battery can be displayed through the light sources of different colors. For example, the charging indication lamp 224 is a multi-color LED. When the rechargeable battery charge capacity does not reach 80%˜90%, the red light source is displayed to inform the user that the rechargeable battery is in an insufficient power state; when the rechargeable battery charge capacity has reached 80%˜90%, the green light source is displayed to inform the user that the rechargeable battery is in its normal use state.

In doing so, a matched pair can be selected from the many-to-many power input and output specifications to charge rechargeable batteries of different specifications, and it is particularly suitable for the basis of the same brand, and hence provides consumers a composite charging cradle capable of integrating multiple input and output specifications.

However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A composite charging cradle for a rechargeable battery, which includes a cradle body and a circuit board disposed in the cradle body, characterized in that:
the cradle body has a plurality of insertion slots for inserting the rechargeable battery therein, and each of the insertion slots is provided therein with at least one set of terminals of different specifications; the circuit board is disposed in the foregoing cradle body and is provided with a plurality of power input ports of different specifications which are exposed out of the cradle body, and an integrated unit for integrating all the foregoing power input ports, and the integrated unit is electrically connected with each of the sets of terminals.

2. The composite charging cradle for a rechargeable battery as described in claim 1, wherein the integrated unit includes a charging control unit, a voltage-stabilizing control unit, and a constant current control unit.

3. The composite charging cradle for a rechargeable battery as described in claim 1, wherein the integrated unit includes a charging indication lamp which is exposed out of the cradle body.

4. The composite charging cradle for a rechargeable battery as described in claim 1, wherein there are two insertion slots which are mutually spaced and arranged side by side, and a foolproof swing plate is disposed in the interval between the two insertion slots.

5. The composite charging cradle for a rechargeable battery as described in claim 1, wherein the cradle body includes a top cover which is provided for the arrangement of the insertion slots, and a bottom cover which opposingly matches and is located below the top cover in order to cover the circuit board.

6. The composite charging cradle for a rechargeable battery as described in claim 1, wherein each of the insertion slots is provided on the wall thereof with a holding spring plate.

7. The composite charging cradle for a rechargeable battery as described in claim 1, wherein the insertion slot is provided at the side end thereof with a reset push rod.

8. The composite charging cradle for a rechargeable battery as described in claim 7, wherein the reset push rod is pushed by a spring to cause a spring thrust.

9. The composite charging cradle for a rechargeable battery as described in claim 7, wherein there is an inclined plane on the front end of the reset push rod.

10. The composite charging cradle for a rechargeable battery as described in claim 1, wherein the circuit board further includes a plurality of power output lines which connect the integrated unit and each set of terminals.
